(19) United States
(12) Patent Application Publication
(10) Pub. No.: US 2013/0058030 A1
(43) Pub. Date: Mar. 7, 2013

(54) EXTERNAL DISK STORAGE SOLUTION

(71) Applicant: Roger S. Mabon, Los Angeles, CA (US)

(72) Inventor: Roger S. Mabon, Los Angeles, CA (US)

(21) Appl. No.: 13/225,186

(22) Filed: Sep. 2, 2011

(51) Int. Cl. G06F 1/16

(52) U.S. Cl. 361/679.32

(57) ABSTRACT

A data storage solution for a computer having a computer stand or a computer display having an opening therein, comprising an external data storage medium and structure to mount the external data storage medium to the rear of the computer stand or computer display.

### FIELD OF THE INVENTION

This invention relates to an external data storage solution that attaches to an all-in-one desktop computer or computer display.

### BACKGROUND OF THE INVENTION

Heretofore, typical external data storage solutions, such as hard drives, solid-state drives, redundant array of independent disks (RAID) and tape drives are housed in external enclosures that are designed to sit on a user's desktop.

These external data storage solutions take up valuable space on the desktop and add to the clutter often on the desktop. What is needed is a data storage unit that does not take up any physical desk space, does not clutter the user workspace and employs a zero-footprint design.

### SUMMARY OF THE INVENTION

The present invention is a data storage unit, such as a hard disk drive, solid-state drive, RAID or tape drive that attaches to a desktop computer or computer display in such a way that the device operates without the need to take up any physical space on the user's desktop. The device mounts to the stand of the computer or the computer display via a specialized mechanical connection resulting in a zero-footprint solution.

The device consists of a data storage unit and specialized mounting hardware. The data storage unit encloses the storage medium and provides a data interface and power connection to the storage medium. Once the mounting hardware is in place, the data storage unit is attached to the all-in-one computer or computer display using a plurality of receptacles on the data storage unit that mate with a plurality of tabs on the mounting hardware. The data storage unit is then secured to the mounting hardware. The mounting hardware is designed to allow the data interface and power cords to pass through an opening in the computer stand or computer display. The data storage unit is thereby attached to the computer or computer display and is off of the user's desk.

### BRIEF DESCRIPTION OF THE DRAWINGS

The foregoing and other objects, features and advantages of the invention will be apparent from the following more particular description of the embodiments of the invention, as illustrated in the accompanying drawing figures:

FIG. 1 is a depiction of the prior art;

FIG. 2 is a side view of an embodiment of the invention;

FIG. 3 is a back view of the embodiment of the invention shown in FIG. 2;

FIG. 4 is an exploded perspective view of the data storage unit;

FIG. 5 is a perspective back view of the data storage unit;

FIGS. 6a, 6b, 6c and 6d are front and back views of the mounting hardware;

FIGS. 7a, and 7b are perspective views of the mounting hardware shown in FIG. 6;

FIGS. 8a, 8b, and 8c are exploded views of the mounting hardware shown in FIG. 6;

FIG. 9 is an exploded view of the embodiment of the invention shown in FIG. 2;

FIG. 10 is a perspective view of the embodiment of FIG. 2, with the mounting hardware installed; and,

FIG. 11 is a side view of the complete installation.

The numerals in the drawings refer to the same parts or elements of the invention, throughout the different views and the specification. The drawing figures are not necessarily drawn to scale, as emphasis is instead being placed upon illustrating the principles of the invention. The views essentially illustrate a preferred embodiment of the invention, and its essential parts or elements.

### DETAILED DESCRIPTION OF THE INVENTION

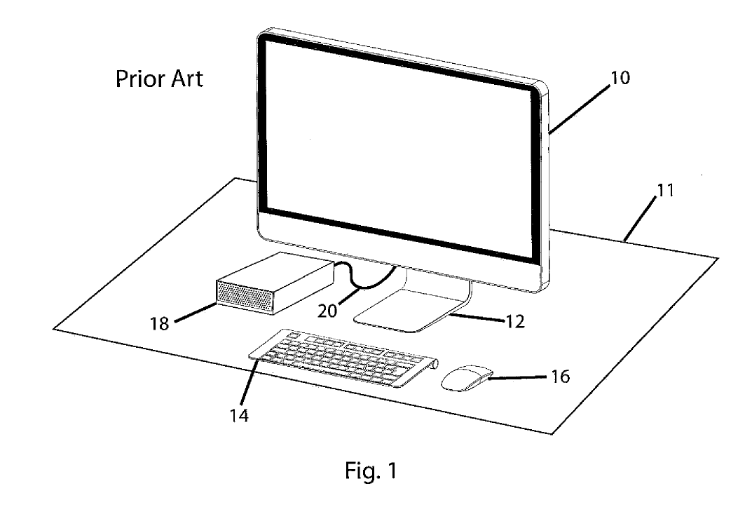

Referring now to the drawings, there is shown in FIG. 1 a depiction of the prior art in which there is a typical computer setup comprising an all-in-one-computer 10 on a computer stand 12 sitting on desktop 11. There is a keyboard 14, a mouse 16 and an external hard drive 18 with a connecting cable 20 to computer 10. External hard drive 18 is simply sitting on the desktop 11, taking up a lot of valuable desk space.

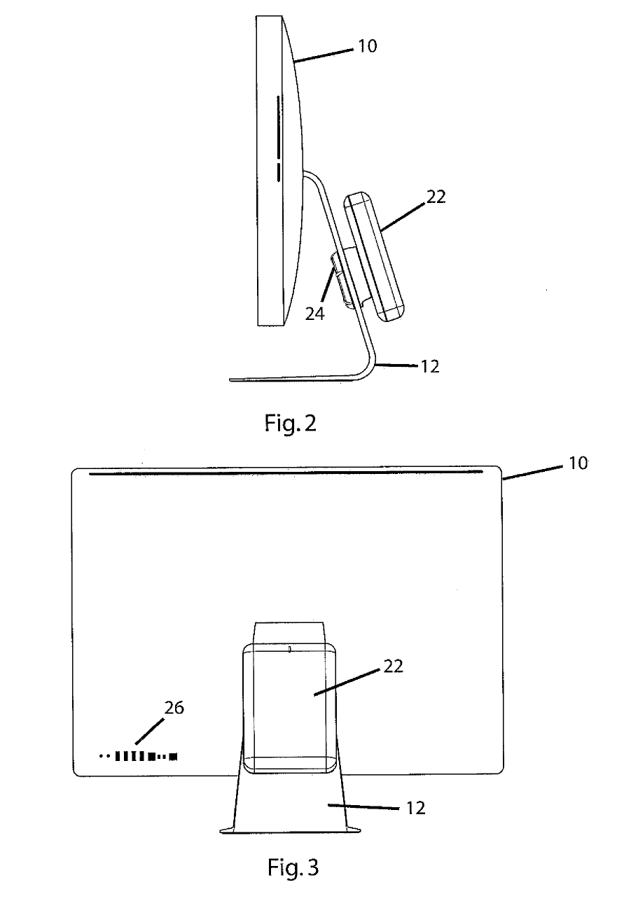

FIGS. 2 through 11 describe a preferred embodiment of the invention. There is shown the same all-in-one computer 10 shown in FIG. 1 with its display stand 12. Also shown is a data storage unit 22 affixed to display stand 12 by mounting hardware 24. On the back of computer 10 are a series of common ports 26, such as data, ethernet, audio and video ports.

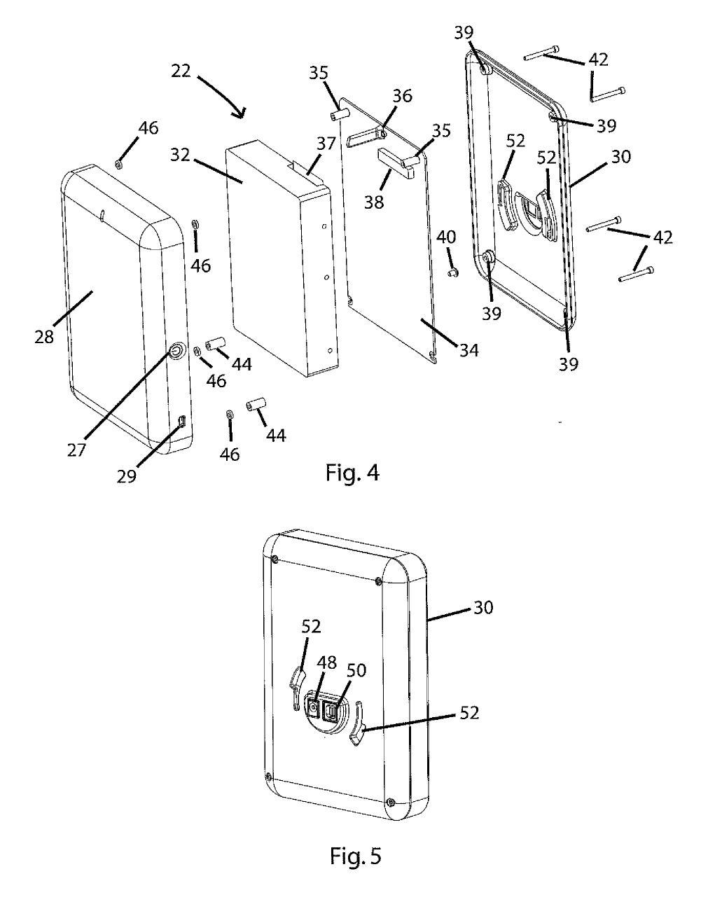

FIGS. 4 and 5 show a detailed depiction of data storage unit 22. Data storage unit 22 comprises an enclosure for the storage medium 32. The enclosure comprises a top or front panel 28 and a bottom or back panel 30. Front panel 28 has an on/off switch 27 and a lock slot 29, which optionally enables data storage unit 22 to be secured to a desk, or other object, using a cable assembly that utilizes lock slot 29, in order to prevent theft.

Data storage unit 22 also comprises storage medium 32 and controller 34. Storage medium 32 has a connection 37 for receiving connector 38 of controller 34. Storage medium 32 and controller 34 are standard hard drive components. Other storage mediums may be used, such as those set forth in the Summary of the Invention.

Controller 34 comprises mounting standoffs 35 for positioning controller 34, a light pipe 36 which lights when the storage medium 32 is operating and a controller interface connector 38 which connects storage medium 32 to controller 34 by storage medium interface connector 37. There is hardware 40 to secure storage medium 32 to front and back panels 28-30 using screws 42, holes 39 in back panel 30, sleeves 44 and locking washers 46.

Back panel 30 comprises a power port 48 and a data port 50. Back panel 30 also comprises a pair of mounting receptacles 52, the outside of which are shown in FIG. 5 and the inside of which are shown in FIG. 4.

Storage medium 32 may be a hard disk drive, a solid-state drive, a RAID, a tape drive, or other storage mediums which are commonly available. Storage medium 32 depicted in this embodiment is a 3.5 inch hard drive.

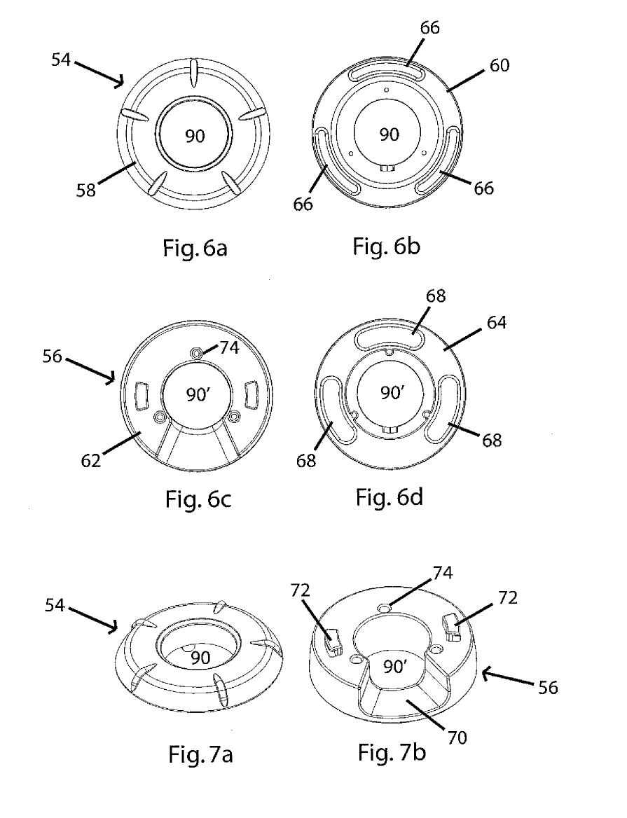

FIGS. 6, 7 and 8 depict the mounting hardware for data storage unit 22. The mounting hardware comprises a front locking disk 54 and a rear locking disk 56. The front side of front locking disk 54 is denoted as 58 and the rear side of front locking disk 54 is denoted as 60.

The front side of rear locking disk 56 is denoted as 62 and the rear side of rear locking disk 56 is denoted as 64. Both locking disks 54 and 56 have a hole 90 and 90′ through the center.

Rear side 60 of locking disk 54 comprises protective pads 66 which aid in insuring a tight fit to stand 12 without scratching the finish of stand 12. The front side of locking disk 56 is denoted as 62 and the rear side of locking disk 56 is denoted as 64. There are also protective pads 68, similar to pads 66, to insure a tight fit to stand 12 without scratching the finish.

Locking disk 56 has a cutout 70 designed to allow the power cable of the computer, and the power cable of the data storage unit, to pass through locking disk 56 and run down towards a power outlet. Locking disk 56 comprises mounting tabs 72 which are male connectors around which rotate female slots 52 of back panel 30, thus mounting data storage unit 22 to stand 12 of computer 10, taking data storage unit 22 off of its usual location on desktop 11. Other types of connectors can be used to attach data storage unit 22 to the stand 12, such as brackets but the mounting tabs and slots are preferred as they are easier to use and more secure.

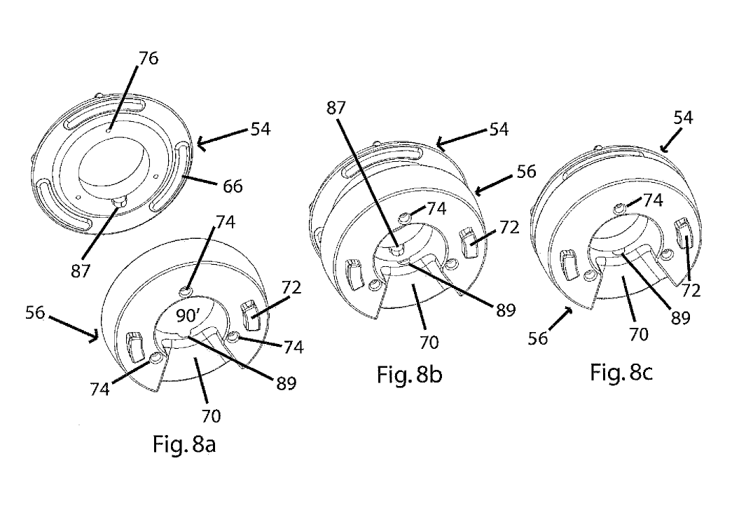

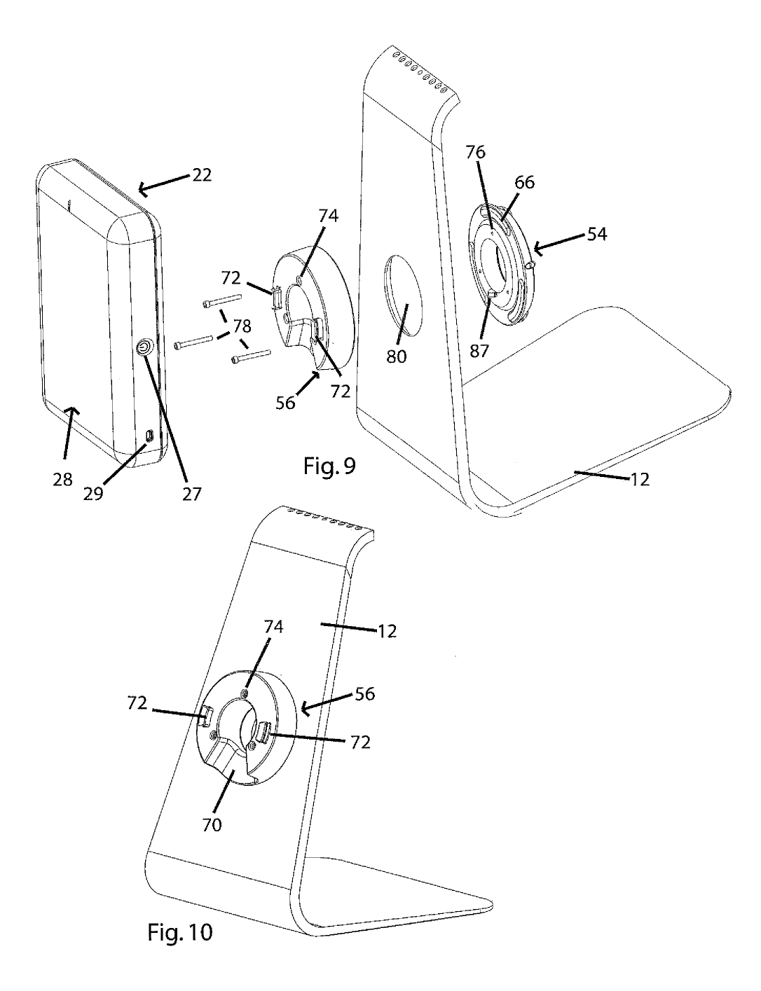

FIGS. 8a, 8b and 8c depict the two portions of the mounting hardware, locking disks 54 and 56, moving closer together around hole 80 in stand 12 (see FIG. 9). Locking disk 54 has a pin 87 which is fits into a notch or cutout 89 in locking disk 56. Pin 87 and notch 89 align the two locking disks 54 and 56, in order to align screw holes 74 in locking disk 56 with receiving holes 76 to affix the two locking disks together. FIG. 8a shows the two disks, 54 and 56 separated, FIG. 8b shows the two disks almost together and FIG. 8c shows the two disks locked together, with pin 87 fitted into notch 89.

FIGS. 9 and 10 show that locking disks 54 and 56 are held together by screws 78 which pass through holes 74 in locking disk 56 and are affixed into receiving holes 76 in locking disk 54.

FIG. 9 is an exploded view of the mounting hardware system affixing data storage unit 22 to stand 12 of computer 10. There is shown the data storage unit 22, screws 78 which pass through holes 74 in locking disk 56, pass through hole 80 and lock into receiving holes 76 in locking disk 54, affixing locking disks 54, 56 to stand 12 so that they are ready to have data storage unit 22 affixed to locking disk 56 by rotating female slots 52 of back panel 30 onto mounting tabs 72 of locking disk 56.

FIG. 10 depicts the mounting hardware mounted onto stand 12, ready for locking data storage unit 22 onto locking disk 56 of the mounting hardware.

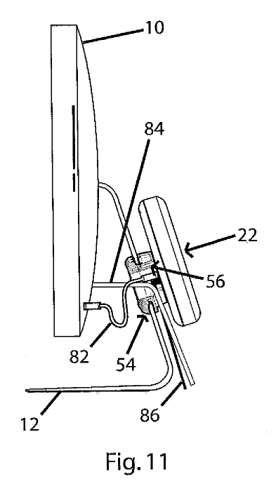

FIG. 11 is a side view showing computer 10, stand 12 and data storage unit 22. Data storage unit 22 is affixed to locking disk 56. Data cable 82 attaches from the rear of computer 10 through holes 80, 90 and 90′ into the data cable receptacle in data storage unit 22. Power cord 84 is the power cable which comes out of the rear of computer 10, passes through the hole 80 in the stand 12 and the holes 90, 90′ through the center of locking disks 54 and 56, down slot 70, to an AC power outlet. Power cord 86 is the power to the data storage unit, which also requires electrical power, and that also passes down slot 70 to an AC power outlet.

The embodiment depicted is an Apple iMac, however there are various other all-in-one computers and computer displays which have a similar structure where the data storage unit can be affixed using the described mounting hardware. Some examples are the Sony Vaio L Series all-in-one computers, the ASUS ET2203/2400 Series of all-in-one PCs and Apple's Cinema or Thunderbolt Display. The invention is compatible with any computer (PC or Mac) or display that has an opening in the stand or support which enable the mounting hardware system to be attached. Some of these have a rectangular, or other shaped openings, which allow the use of the same, or slightly modified (in the shape of the opening), mounting hardware system.

The embodiment depicts the use of a USB interface, but the invention could use any type of interface, such as FireWire, SAS, SCSI, Fibre Channel, Thunderbolt, as well as other interfaces.

Having thus described the invention, I claim:

1. A data storage solution for a computer having a computer stand or a computer display having an opening therein, comprising an external data storage medium and structure to mount the external data storage medium to the computer stand or computer display comprising:
a) an enclosure to hold the external data storage medium;
b) mounting hardware to attach the enclosure to the computer stand or computer display;
c) said enclosure comprising a front panel and a back panel adapted to encase said external data storage medium;
d) said back panel comprising slots for receiving mounting tabs;
e) said mounting hardware comprising a front locking disk and a rear locking disk;
f) said front locking disk and rear locking disk each having openings which are concentric with the opening in the computer stand or computer display;
g) means to attach the front locking disk and the rear locking disk together, one on each side of the opening in the computer stand or computer display;
h) said rear locking disk have mounting tabs adapted to connect to the slots of said back panel.

2. The data storage solution of claim 1 in which the front and rear locking disks each have protective pads to protect the surface of the computer stand or computer display.

3. The data storage solution of claim 1 in which the front and rear locking disks are locked together using screws.

4. The data storage solution of claim 1 in which the rear locking disk has a slot therein to allow the computer power cable to pass through to a power outlet.

5. The data storage solution of claim 1 in which the slots rotate onto the mounting tabs.

6. The data storage solution of claim 1 in which the data storage unit connects to the computer by an interface of a USB, Fire Wire, SAS, SCSI, Fibre Channel or Thunderbolt.

7. The data storage solution of claim 1 further comprising a data cable which attaches from the rear of the computer into a data cable receptacle in the data storage unit.

8. The data storage solution of claim 7 in which the data cable passes through the opening in the computer stand or computer display and the openings in the front and rear locking disks.

9. The data storage solution of claim 1 in which one locking disk has a pin and the other locking disk has notch, the pin and notch mating together to align the disks together.

10. A data storage solution for a computer having a computer stand or a computer display having an hole therein, comprising an external data storage medium and structure to mount the external data storage medium to the computer stand or computer display comprising:
a) an enclosure to hold the external data storage medium;
b) mounting hardware to attach the enclosure to the computer stand or computer display;
c) said enclosure comprising a front panel and a back panel adapted to encase said external data storage medium;
d) said back panel comprising a plurality of slots for receiving mounting tabs;
e) said mounting hardware comprising a front locking disk and a rear locking disk each of which has a hole there through;
f) said front locking disk and rear locking disk each having a hole which are concentric with the hole in the computer stand or computer display;
g) attachment means to connect the front locking disk and the rear locking disk together, one on each side of the hole in the computer stand or computer display;
h) said rear locking disk have a plurality of mounting tabs adapted to mate to the slots of said back panel; and,
i) one locking disk having a pin and the other locking disk having a notch, the pin and notch mating together to align the disks together.

11. The data storage solution of claim 10 in which the front and rear locking disks each have protective pads to protect the surface of the computer stand or computer display.

12. The data storage solution of claim 10 in which the front and rear locking disks are locked together using screws.

13. The data storage solution of claim 10 in which the rear locking disk has a slot therein to allow the computer power cable to pass through to a power outlet.

14. The data storage solution of claim 10 in which the slots rotate onto the mounting tabs.

15. The data storage solution of claim 10 in which the data storage unit connects to the computer by an interface of a USB, Fire Wire, SAS, SCSI, Fibre Channel or Thunderbolt.

16. The data storage solution of claim 10 further comprising a data cable which attaches from the rear of the computer into a data cable receptacle in the data storage unit.

17. The data storage solution of claim 16 in which the data cable passes through the opening in the computer stand or computer display and the openings in the front and rear locking disks.
